(19) United States
(12) Patent Application Publication
(10) Pub. No.: US 2006/0079424 A1
(43) Pub. Date: Apr. 13, 2006

(54) BUFFERED ACID CLEANER AND METHOD OF PRODUCTION

(76) Inventor: Stephen C. Perry, Norwood, MA (US)

Correspondence Address: MALIN HALEY AND DIMAGGIO, PA, 1936 S ANDREWS AVENUE, FORT LAUDERDALE, FL, 33316, US

(21) Appl. No.: 11/162,749

(22) Filed: Sep. 21, 2005

Related U.S. Application Data
(60) Provisional application No. 60/522,387, filed on Sep. 23, 2004.

(51) Int. Cl. C09D 9/00

(52) U.S. Cl. 510/201

(57) ABSTRACT

A composition for cleaning oxide discoloration, rust, and high temperature-related scale from stainless steel and other metals. The composition comprises a nitrogen acid salt produced by the mixture of urea and an acid and a gelling agent. The preferred nitrogen acid salt used in the composition is urea hydrochloride, which is a buffered acid cleaner. Synthetic smectite clay is the preferred thixotropic gelling agent. Both of these ingredients are non-hazardous and do not produce any toxic or corrosive fumes. The invention also includes the method of preparing the composition.

### FIELD OF THE INVENTION

This invention relates to a buffered acid cleaner for cleaning metal surfaces, especially stainless steel surfaces, and a method for manufacturing buffered acid cleaner.

### DESCRIPTION OF RELATED ART

Pickling is the removal from stainless steel of any type of high temperature-related scale caused by heat treatment or weld burn. If stainless steel is heated by welding, heat treating, or any other means to the point where a multi-colored oxide layer (referred to as “bluing”) is evident on the surface, this condition is indicative of a chromium-depleted layer on the surface of the steel below the oxide layer. Low chromium content in stainless steel results in low corrosion resistance. Acid cleaners, also called pickling pastes, are the most effective means of restoring maximum corrosion resistance to the affected stainless steel. Pickling is an acid treatment used to remove high temperature scale and red rust from the steel or from corrosion of contaminant iron and steel particles. High temperature dark scale is undesirable for aesthetic reasons and because it reduces the corrosion resistance of the underlying steel layer.

Several patents describe pickling agents produced from the mixture of an acid or acids and urea. A thorough review of the prior art is provided in the published patent application US 2003/0004080 A1, which itself seeks patent protection for a pickling agent containing urea and the method of producing that agent. In most of the prior art reviewed, nitric acid was used as a component of the pickling agent in those compositions. When nitric acid contained in those pickling agents oxidizes metal, harmful NOₓ fumes and nitrates are released as a by-product of the pickling process. Fumes of the various nitrous oxides are toxic to humans working in close proximity to the pickling agent, and both the fumes and the nitrates are environmental hazards. Alternative pickling methods have used hydrogen peroxide, sulfuric acid, and Fe³⁺ as oxidizing agents, thereby circumventing the problems inherent in usage of nitric acid. However, pickling compositions using these particular alternative agents are not as effective as compositions using nitric acid.

### SUMMARY OF THE INVENTION

A composition of matter for cleaning oxide discoloration and rust from stainless steel surfaces, comprising a nitrogen acid salt, preferably urea hydrochloric acid salt, as a pickling agent and synthetic smectite clay as a gelling or thickening agent, and a method for manufacturing the composition. The composition can take the form of thixotropic paste, spray, or gel.

The method of preparing the buffered acid cleaner uses preferably muriatic acid, although many other acids or blends of acids can be substituted in its place. Acids that can be substituted in place of muriatic acid include, among others, acetic acid, ascorbic acid, boric acid, citric acid, lactic acid, oxalic acid dehydrate, phosphoric acid, salicylic acid, and sulfonic acid. To the muriatic acid, add slowly with mixing prilled urea. Mix at a temperature range of 65 to 80 degrees Fahrenheit, but preferably at 72 degrees Fahrenheit (standard room temperature). Add 2.0% synthetic smectite clay to the buffered acid cleaner mixture to form a thixotropic paste, 1.0% to form a gel, or 0.5% to form a spray. The composition can be used to coat stainless steel to remove bluing and corrosion and to enhance the corrosion resistance of the steel without the need for passivation.

An object of this invention is to provide a pickling paste that can be used to clean high temperature-related scale formation, oxide discoloration, and rust from stainless steel surfaces, and that does not deleteriously result in the removal of chromium content from the steel.

A further object of this invention is to provide a safe, inexpensive, and easily used buffered acid cleaner for cleaning stainless steel surfaces without the emission of fumes harmful to the environment and to said steel.

Another object of this invention is to remove the hazards associated with toxic NOₓ fumes and nitrates, which are produced by the use of nitric acid as a component of some currently-used pickling pastes, through the usage of alternative safer acids and blends of acids.

Yet another object of this invention is to use a gelling agent that is safe and inert to increase the efficacy of the product, where thickeners currently used in other pickling paste products are not inert or safe, and to provide a non-fuming buffered acid cleaner for usage in food processing and medical treatment locations where the presence of toxic fumes would pose a serious health risk.

Still another object of this invention is to use a synthetic thixotropic gelling agent that does not produce harmful byproducts when heated and that leaves no hazardous wastes to be cleaned up after its usage in the pickling process.

### DETAILED DESCRIPTION

A composition of matter and method for producing a buffered acid cleaner, also known as a pickling agent, to clean oxide discoloration, rust, and high temperature-related scale from stainless steel and other metals, and that can be used as a paste, spray, or gel.

The composition is composed primarily of a combination of a nitrogen acid salt, preferably urea hydrochloric acid salt, and a gelling agent, preferably a synthetic smectite clay. Urea hydrochloric acid salt, also known as urea hydrochloride, is non-hazardous. The composition is non-hazardous and biodegradable, and it does not emit any toxic or corrosive fumes. Because of these qualities, the composition will be designated as safe for transport and clean up by the U.S. Department of Transportation, and therefore, will not be a USDOT regulated product. Furthermore, the composition acts rapidly to remove the corrosion and oxidation from the metal, and retains its effectiveness even after prolonged storage.

The method of preparing the buffered acid cleaner uses preferably muriatic acid (65 parts of 20 degree baume HCl (31.45% minimum and 32.5% average by weight)). To the muriatic acid, add slowly with mixing prilled urea (35 parts). Mix at a temperature range of 65 to 80 degrees Fahrenheit and preferably at room temperature (72 degrees Fahrenheit). In another embodiment of the composition, the method of producing the buffered acid cleaner uses muriatic acid (130 parts of 20 degree baume HCl (31.45% minimum and 32.5% average by weight)). To the muriatic acid, add slowly with mixing prilled urea (35 parts). Mix at a temperature range of 65 to 80 degrees Fahrenheit and preferably at room temperature (72 degrees Fahrenheit). This embodiment represents a form of the product of increased strength and effectiveness. Add 2.0% synthetic smectite clay to the buffered acid cleaner mixture to form a thixotropic paste, 1.0% to form a gel, or 0.5% to form a spray. Unlike the gelling agents currently used in other pickling agent products, the novel synthetic smectite clay, which is a thixotropic thickener, is inert and safe. The inert nature of the synthetic smectite clay adds significantly to the efficacy of the product because it does not react with the pickling agent or with other chemicals in the vicinity of its use. Furthermore, this synthetic gelling agent does not produce harmful byproducts when heated and leaves no hazardous wastes to be cleaned up after its usage in the pickling process.

Although the preferred embodiment uses muriatic acid to produce the composition, many other acids, and even some mixtures of two or more acids, can be substituted in its place. For example, one contemplated acid mixture that may be substituted for the preferred embodiment is a blend of muriatic acid and phosphoric acid. Acids that can be substituted in the composition in place of muriatic acid include, among others, acetic acid, ascorbic acid, boric acid, citric acid, lactic acid, oxalic acid dehydrate, phosphoric acid, salicylic acid, and sulfonic acid. These acids can be substituted in the same percentages by weight as described for the use of muriatic acid. In any event, the use of nitric acid will be avoided in this composition so as to eliminate the threat to humans and the environment from toxic and corrosive NOₓ fumes and nitrates, which constitute a major problem with the usage of other currently marketed pickling agents.

Because both the nitrogen acid salt and synthetic smectite clay are non-hazardous, the composition can be used as a buffered acid cleaner on stainless steel in food processing areas, hospitals and other medical treatment areas, and in other locations where the use of other hazardous fume-producing pickling agents would pose a serious health risk to humans. In addition, stainless steel that is pickled using this composition need not undergo passivation, which saves time and money during the process of inducing the corrosion-resistant properties of stainless steel.

The instant invention has been shown and described herein in what is considered to be the most practical and preferred embodiment. The applicant recognizes, however, that departures may be made therefrom within the scope of the invention and that obvious modifications will occur to a person skilled in the art.

What is claimed is:

1. A composition that is a buffered acid cleaner for cleaning oxide discoloration, rust, and high temperature-related scale from stainless steel and other metals comprising:
a nitrogen acid salt produced by the mixture of urea and an acid; and
a gelling agent.

2. The composition of claim 1, wherein the nitrogen acid salt is preferably urea hydrochloric acid salt produced by combining urea and hydrochloric acid.

3. The composition of claim 1, wherein the gelling agent is preferably an inert, non-hazardous, synthetic smectite clay.

4. The composition of claim 1, wherein the acid chosen for combining with urea is chosen from one or blends of two or more of the following: muriatic acid, acetic acid, ascorbic acid, boric acid, citric acid, lactic acid, oxalic acid dehydrate, phosphoric acid, salicylic acid, and sulfonic acid.

5. The composition of claim 1, wherein the acid chosen for combining with urea to form the nitrogen acid salt is a blend of muriatic acid and phosphoric acid.

6. The composition of claim 1, wherein the composition is non-hazardous, biodegradable, and does not emit any toxic or corrosive fumes.

7. The composition of claim 1, wherein the composition acts rapidly to remove corrosion and oxidation from stainless steel or other metal.

8. The composition of claim 1, wherein the composition retains effectiveness during prolonged storage.

9. The composition of claim 1, wherein the composition is used as a buffered acid cleaner on stainless steel in food processing areas, hospitals and other medical treatment areas, and in other locations where the use of other hazardous, fume-producing pickling agents would pose a serious health risk to humans.

10. The composition of claim 1, wherein stainless steel that is pickled using this composition need not undergo passivation, which saves time and money during the process of inducing the corrosion-resistant properties of stainless steel.

11. A method for preparing a buffered acid cleaner for cleaning oxide discoloration, rust, and high temperature-related scale from stainless steel and other metals, said method comprising the following steps:
at a temperature range of 65 to 80 degrees Fahrenheit, but preferably at 72 degrees Fahrenheit, add prilled urea (35 parts) slowly with mixing to muriatic acid (65 parts of 20 degree baume HCl (31.45% minimum and 32.5% average by weight)); and
add synthetic smectite clay to the buffered acid cleaner mixture.

12. The method of claim 11, wherein 2.0% by weight synthetic smectite clay is added to the buffered acid cleaner mixture to form a thixotropic paste.

13. The method of claim 11, wherein 1.0% by weight synthetic smectite clay is added to the buffered acid cleaner mixture to form a gel.

14. The method of claim 11, wherein 0.5% by weight synthetic smectite clay is added to the buffered acid cleaner to form a spray.

15. A method for preparing a buffered acid cleaner for cleaning oxide discoloration, rust, and high temperature-related scale from stainless steel and other metals, said method comprising the following steps:
at a temperature range of 65 to 80 degrees Fahrenheit, but preferably at 72 degrees Fahrenheit, add prilled urea (35 parts) slowly with mixing to muriatic acid (130 parts of 20 degree baume HCl (31.45% minimum and 32.5% average by weight)) to form the buffered acid cleaner; and
add synthetic smectite clay to the buffered acid cleaner mixture.

16. The method of claim 15, wherein 2.0% by weight synthetic smectite clay is added to the buffered acid cleaner mixture to form a thixotropic paste.

17. The method of claim 15, wherein 1.0% by weight synthetic smectite clay is added to the buffered acid cleaner mixture to form a gel.

18. The method of claim 15, wherein 0.5% by weight synthetic smectite clay is added to the buffered acid cleaner to form a spray.
